(19) United States
(12) Patent Application Publication
(10) Pub. No.: US 2006/0232558 A1
(43) Pub. Date: Oct. 19, 2006

(54) Virtual keyboard

(76) Inventor: Huan-Wen Chien, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/106,447

(22) Filed: Apr. 15, 2005

(51) Int. Cl. G09G 5/00

(52) U.S. Cl. 345/168

(57) ABSTRACT

The present invention discloses a virtual keyboard, which includes a virtual region, at least two vibration sensors, a storage unit and a processing unit. The virtual region is formed on a surface and has a plurality of virtual keys. The vibration sensors are provided on the surface. The storage unit is used to store a plurality of data, each of the plurality of data recording an actual location and signification of each of the virtual keys. The processing unit is electronically connected to the vibration sensors and the storage unit. When a vibration signal is caused by touching the virtual region, each of the vibration sensors receives the vibration signal and respectively sends an output signal corresponding to the vibration signal to the processing unit. The processing unit determines a vibration source location of the vibration signal based on the output signals and locates a knocked virtual key by comparison of the vibration source location and the actual location recorded in the data, and generates a key signal according to the signification of the knocked key of the virtual keys.

### BACKGROUND OF THE INVENTION

(1) Field of the Invention

The invention relates to the design of a keyboard, and more particularly to a virtual keyboard without tangible keys.

(2) Description of the Prior Art

Keyboards have become indispensable one of the peripheral devices of computers, used to input characters, numerals or commands. Nowadays, more and more computer users pay much attention to not only CPUs, memories, hard disk drives or graphic cards etc., which is highly related to performance of a computer system, but also keyboards and mice. This is because a number of computer users have appreciated that although the current CPUs with high performance, such as Intel Pentium 4, are satisfactory for use in home or office, the user interface devices, such as keyboards or mice, still play an important role. To some degree, although mice are able to replace keyboards, keyboards are still essential and convenient for some inputting tasks. That is, better keyboards are desired.

The traditional computer keyboard consists of a plurality of tangible keys, a tangible conductive membrane under the keys, and a processing unit. One of the disadvantages of the traditional keyboard is that it occupies too much space, which is difficult to stow. On the other hand, the keyboards specifically designed for desktop personal computers are not suitable for use in notebook computers because of being inconvenient to carry. Furthermore, the keyboard designed for a desktop personal computer cannot be used by other electronic apparatus, and thus users have to buy specific input device. For example, the keyboard designed for a desktop personal computer cannot be used by a PDA and thus a specific input device is required. Obviously, this is inconvenient and uneconomical for uses. Therefore, in order to meet the requirements of uses in compatibility and convenience, keyboard manufacturers have presented a number of solutions to solve the above problems.

Referring to FIG. 1, U.S. Pat. No. 6,650,318 discloses a virtual keyboard 60, which consists of a laser source 70, a sensor 80 and a processing unit 90. The laser source 70 emits a laser beam to form a virtual keyboard image 180 after shaped. The virtual keyboard image 180 includes a plurality of key images. If there is a finger or an object placed on the virtual keyboard image 180, the laser beam will be reflected and sensed by the sensor 80. Based on angle and time required for reflection, the processing unit 90 is able to figure out which key is knocked. Therefore, the processing unit 90 outputs a character, a numeral or even a command corresponding to the knocked key to a computer host 95.

However, the disadvantages of the virtual keyboard 60 are shown as follows. Firstly, the laser source 70 used in the virtual keyboard 60 is probably harmful to human eyes, especially to children or younger users, if they directly look at the laser source 70. Secondly, the laser source 70 used in the virtual keyboard 60 continuously emits the laser beam to form the virtual keyboard image 180, which leads to significant power consumption. That is, if there is no adaptor or external electric power source on hand, the virtual keyboard 60 is not suitable for use in a portable electronic apparatus.

Therefore, there is a need to improve the above traditional tangible or virtual keyboard.

### SUMMARY OF THE INVENTION

The present invention discloses a virtual keyboard, including a virtual region, at least two vibration sensors, a storage unit and a processing unit. The virtual region is formed on a surface and has a plurality of virtual keys. The vibration sensors are provided on the surface. The storage unit is used to store a plurality of data, each of the plurality of data recording an actual location and signification of each of the plurality of virtual keys. The processing unit is electronically connected to the vibration sensors and the storage unit. When a vibration signal is caused by touching the virtual region, each of the vibration sensors receives the vibration signal and respectively sends an output signal corresponding to the vibration signal to the processing unit. The processing unit determines a vibration source location of the vibration signal based on the output signals, locates a knocked virtual key by comparison of the vibration source location and the actual location recorded in the data, and generates a key signal according to the signification of the knocked key of the virtual keys.

The virtual keyboard further includes a wireless communication unit or a wired communication unit, used to send the key signal to a device, such as a computer host.

Furthermore, the surface of the virtual region can exist on any object, preferably a platform, such as a rigid plastic plate, a plate made of wood, a glass plate or a metallic plate, as well as a flexible plate including a soft plastic sheet, a rubber plate or a piece of paper.

Under the support of a software interface executed on the device, the present invention enables a user to input the data into the device. As mentioned above, each data records each of the actual locations and the significations of the plurality of virtual keys. This means that in the present invention a user is allowed to define each of the locations and significations of the plurality of virtual keys.

In addition, under the support of a handwriting software, the present invention further includes a virtual handwriting board provided for handwriting inputs. Also, under the support of a touch pad software, the present invention further includes a virtual touch pad provided for touch inputs.

### BRIEF DESCRIPTION OF THE DRAWINGS

The present invention will now be specified with reference to its preferred embodiment illustrated in the drawings, in which

FIG. 1 shows a schematic view depicting a conventional virtual keyboard;

FIG. 2 shows a circuit diagram depicting the first embodiment of the present virtual keyboard;

FIG. 3 shows a schematic view depicting the first embodiment of the present virtual keyboard;

FIG. 4 shows a circuit diagram depicting the second embodiment of the present virtual keyboard;

FIG. 5 shows a circuit diagram depicting the present virtual keyboard, in which three vibration sensors are used; and

FIG. 6 shows a perspective view depicting a planar keyboard implementing the present invention.

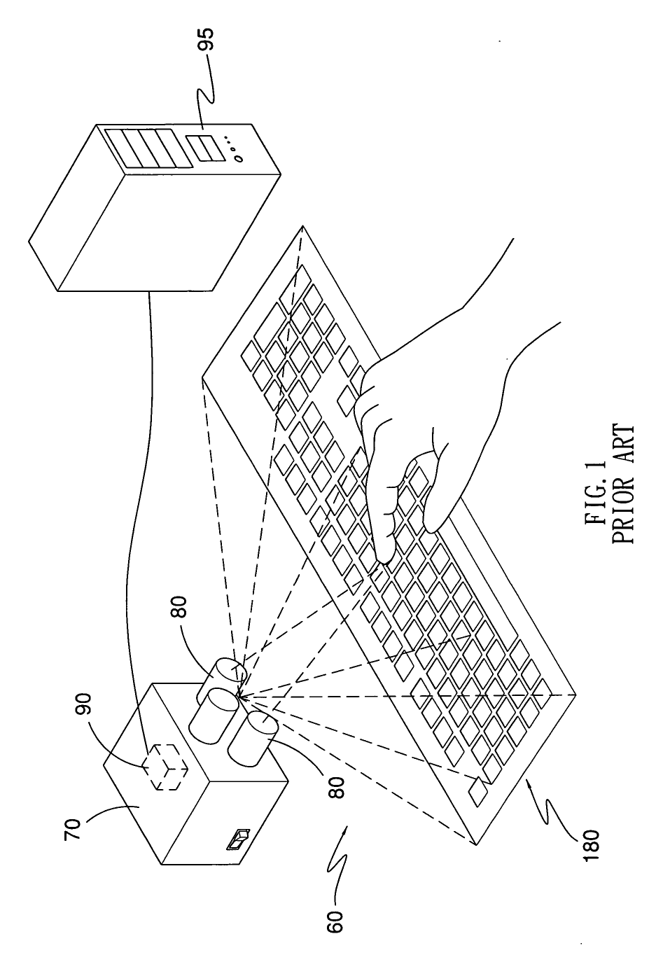

### DESCRIPTION OF THE PREFERRED EMBODIMENT

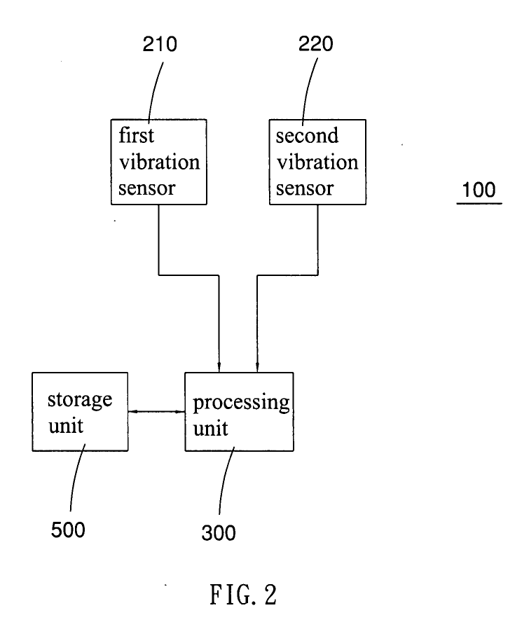

The present invention discloses a virtual keyboard. FIG. 2 shows a circuit diagram depicting the first embodiment of the present virtual keyboard. The virtual keyboard 100 includes at least two vibration sensors 210, 220, a processing unit 300 and a storage unit 500. The vibration sensors 210, 220 and the storage unit 500 are electrically connected to the processing unit 300, respectively.

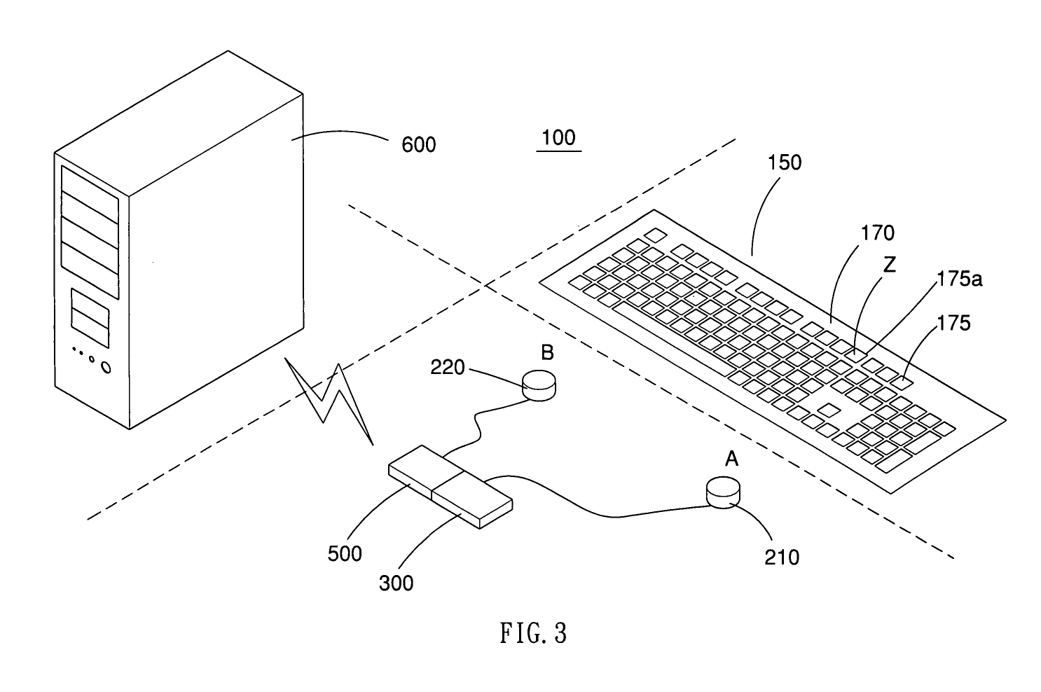

FIG. 3 shows a schematic view depicting the present virtual keyboard 100, which further includes a virtual region 170 formed on a plane 150. The virtual region 170 can be an imaginary region formed on a tangible plane or a region really plotted by a user. The plane 150 can exist on any platform, such as a rigid plate including a rigid plastic plate, a plate made of wood, a glass plate or a metallic plate, as well as a flexible plate including a soft plastic sheet, a rubber plate or a piece of paper. Furthermore, the plane 150 can be a computer desk, a dinning table, a monitor surface, a rigid/flexible plate or a piece of paper having a plurality of key patterns printed thereon.

FIG. 3 further shows the detailed construction of the virtual region 170, which is further divided into a plurality of tiny sub-regions, each representing a plurality of virtual keys 175, which looks like a tangible keyboard consisting of a plurality of keys. On the other hand, it is understood by the person skilled in the art that the virtual region 170 can be formed on a piece of paper or a planar plate, which has a plurality of key patterns printed thereon used to represent the plurality of virtual keys 175. In this way, a user is able to manipulate the virtual keyboard 100 using the plurality of key patterns. Furthermore, for the user familiar with the relative arrangement of the keys on a tangible keyboard, the key patterns even can be omitted.

As shown in FIG. 3, the first vibration sensor 210 and the second vibration sensor 220 are located on the points A and B, respectively, outside the virtual region 170. It is understood that if any of the virtual key 175 is knocked or pressed, a vibration signal (vibration wave) will be caused. Therefore, the knocked virtual key 175 can be viewed as a vibration source, which is designated as Z. Once the vibration signal from the vibration source Z is received by the first vibration sensor 210 and the second vibration sensor 220, respectively, the elapsed time and the amplitude sensed by the first vibration sensor 210 and the second vibration sensor 220 are different because the distance A-Z differs the distance B-Z. Elapsed time difference is caused by the distance difference between the distance A-Z and the distance B-Z. The amplitude ratio represents the reciprocal of the square of the ratio of the distance A-Z to the distance B-Z. Therefore, it is easy to determine the location of the vibration source Z through calculating the elapsed time difference and the amplitude ratio of the vibration signal using the above formula.

Referring to FIG. 2 and FIG. 3, when a vibration signal is generated by any of the virtual keys 175 knocked on the virtual region 170, the first vibration sensor 210 and the second vibration sensor 220 will receive the vibration signal and then send an output signal, corresponding to the vibration signal, to the processing unit 300, respectively. As a result, the processing unit 300 is able to determine the location of the vibration signal from the vibration source Z based on the output signal and the above-mentioned formula. The storage unit 500 stores a plurality of data, which records the actual location and signification of each of the virtual keys 175. Therefore, the processing unit 300 is able to locate the knocked virtual key 175a, as the vibration source Z, simply by means of the comparison of the location of the vibration source Z to the actual location recorded in the data. Then, the output signal corresponding to the knocked virtual key is sent to a computing device 600, such as a computer host or a PDA.

In the present invention, the storage unit 500 and the processing unit 300 can be located in two separated packages. Alternatively, the storage unit 500 of the present invention and the processing unit 300 can be packed together into a single package. Additionally, if the virtual region 170 is formed on a planar plate, the processing unit 300 can be packed or integrated into the planar plate. Importantly, in another embodiment the storage unit 500 can be provided by the above-mentioned computing device 600. In this way, to derive a key signal according to the signification of the knocked key of the virtual keys 175a, the processing unit 300 only needs to send a processing signal which is the information of the vibration source location or even both the time information and amplitude information about the vibration signal sensed by the first and the second vibration sensors 210, 220 to the computing device 600. Thereafter, the computing device 600 computes and derives the key signal according to the signification of the knocked key of the virtual keys 175a through its built-in CPU.

From the description of the above embodiment, it is understood that virtual keyboard 100 makes use of sensing the location of the vibration signal generated in the virtual region 170 to determine which virtual key 175 is knocked. That is, in contrast to prior art using laser beam, any light source is needless for the present invention. Obviously, any problems accompanied by using laser beam can be avoided, which also means that less power consumption and being harmless to user's eyesight are achieved in the present invention.

In addition, the present invention further includes a software interface, not shown, executed in the computing device 600, for a user to set some data into the storage unit 500. The setting method is described in detail as follows.

At first, a certain position, e.g. a virtual key, in the virtual region 170 is knocked by a user. The processing unit 300 determines the coordinate of the position based on the elapsed time difference and/or the amplitude sensed by the first vibration sensor 210 and the second vibration sensor 220. Meanwhile, the storage unit 500 stores a piece of data representing the coordinate and its signification defined by the user.

As mentioned above, each data records each of the actual locations and the significations of the plurality of virtual keys 175. This means that in the present invention a user is allowed to define each of the locations and significations of the virtual keys 175. For example, if there is only numeral needed to be inputted, the user is allowed to define that the virtual keys 175 all represent numerals through the software interface. In addition, the area and location of the virtual keys 175 are varied depending on the user.

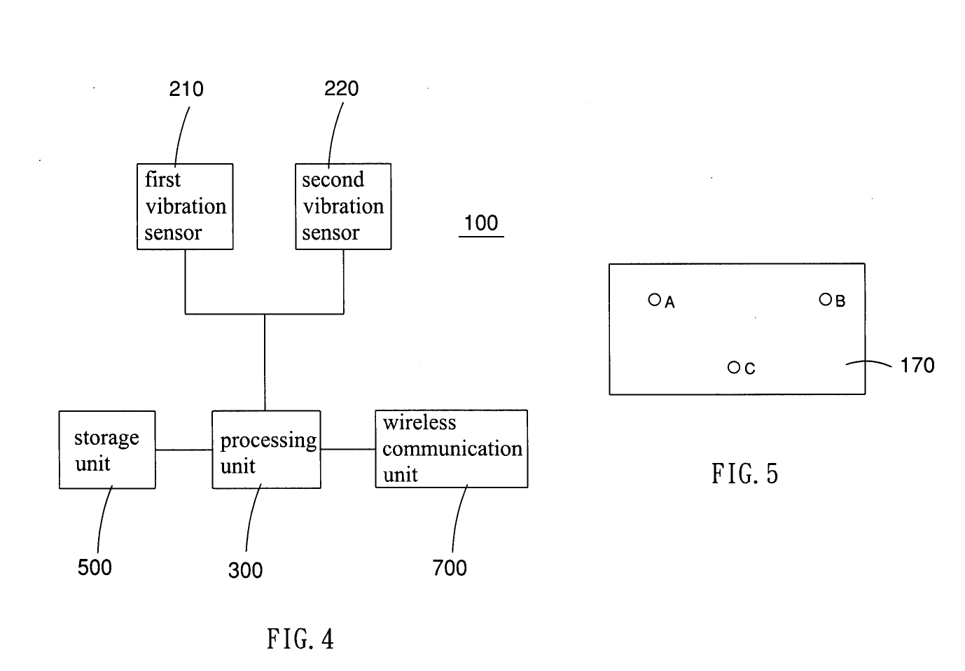

FIG. 4 shows a circuit diagram depicting the second embodiment of the present invention. Compared with the first embodiment, in the second embodiment, a wireless communication unit 700, such as a Bluetooth or a Wi-Fi module, is added. Through the wireless communication unit 700, the processing unit 300 is able to transmit the signal corresponding to any knocked virtual key 175 to a certain device, such as the computing device 600 shown in FIG. 3 in wireless manner. Of course, the wireless communication unit 700 can be replaced by a wired communication unit, such as a cable, for transmitting the signal corresponding to any knocked virtual key 175.

FIG. 5 shows another embodiment in which three vibration sensors are used. Points A, B and C represent the vibration sensors identical to the one shown in FIG. 3. Please note that in this embodiment the three vibration sensors are allowed to be partially or fully located in or outside the virtual region 170. The embodiment with reference to FIG. 4 is illustrated with three vibration sensors all located inside the virtual region. Since the absolute location of a vibration source on a plane can be determined by three points, the location of the vibration source can be determined by elapsed time difference or amplitude ratio of the vibration source among these three points.

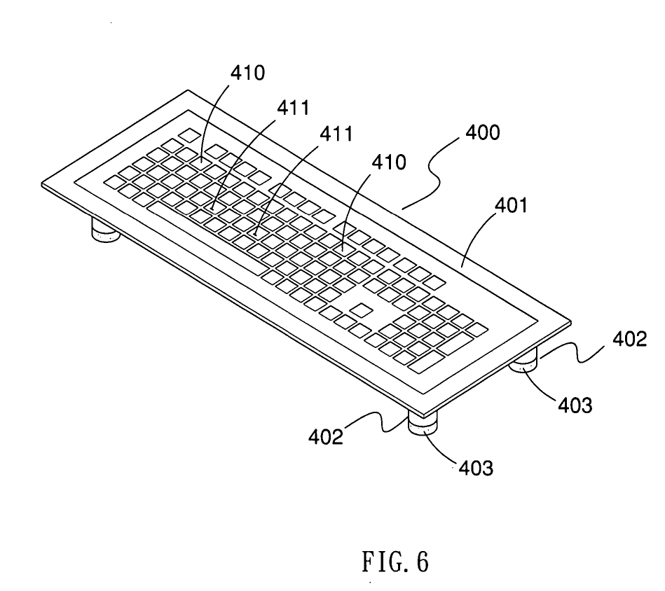

FIG. 6 shows a perspective view depicting a planar keyboard 400 implementing the present invention. The planar keyboard 400 further includes a rigid plate 401, a plurality of foot stands 402, and the elements, such as a processing unit and two vibration sensors, mentioned in the above-mentioned first and second embodiments, which are omitted for simplification. There is a plurality of key patterns, such as numerals, characters or control keys, printed on the surface of the rigid plate 401. Alternatively, a user is allowed to fill in, draw or attach the desired key patterns. Each of the plurality of key patterns represents a virtual key 410. In addition, a vibration-absorbing pad 403 is respectively provided on the bottom of each of the foot stands 402, which is used to absorb vibration generated by knocking the planar keyboard 400 and prevent the vibration sensors from being interfered by vibration from outside of the planar keyboard 400. Furthermore, please note that there are two positioning protrusions 411 formed on two of the plurality of key patterns, which are similar to the protrusions respectively formed on keys F and J provided by a traditional tangible or mechanical keyboard.

On the other hand, if one of the virtual keys is pressed and another one of the virtual keys, such as Ctrl-A, is knocked by a user simultaneously, the surface tension of the planar keyboard 400 will be altered by the user keeping on pressing the virtual key and thus cause change in some physical characters of the vibration wave, such as decrease in transmitting speed or attenuation in amplitude of the vibration wave. The degree of alteration of some physical characters of the vibration wave can be sensed by the vibration sensors and the processing unit 300. The alteration is collected and stored by the storage unit 500 as an object character information. That is, the present virtual keyboard also allows the user to press two keys at the same time.

In addition, in case under the support of a software to perform functions of a touch pad, the virtual region further includes a virtual touch pad which enables the present invention to work as a touch pad. In further detail, when the surface of the virtual touch pad is slightly touched by a moving object, such as a finger of a user, the vibration sensors is able to detect that the vibration source is moving in a line with time. The processing unit 300 determines that the user is moving a cursor, just like the cursor moving function provided by a touch pad or a mouse, and then moves the cursor or scroll a page based on the moving of the object. Likewise, under the support of a software to perform a handwriting function, the virtual region further includes a handwriting board which enables the present invention to provide handwriting functions.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A virtual keyboard, comprising:
a virtual region, formed on a surface and having a plurality of virtual keys;
at least two vibration sensors, provided on the surface;
a storage unit, used to store a plurality of data, each of the plurality of data recording an actual location and signification of each of the plurality of virtual keys; and
a processing unit, electronically connected to the vibration sensors and the storage unit;
wherein when a vibration signal is caused by touching the virtual region, each of the vibration sensors receives the vibration signal and respectively sends an output signal corresponding to the vibration signal to the processing unit, the processing unit determines a vibration source location of the vibration signal based on the output signals, and locates a knocked key of the virtual keys by comparison of the vibration source location and the actual location recorded in the data, and generates a key signal according to the signification of the knocked key of the virtual keys

2. The virtual keyboard according to claim 1, wherein the processing unit determines the vibration source location based on elapsed time difference of the vibration signal and/or amplitude ratio of the vibration signal received by the vibration sensors, respectively.

3. The virtual keyboard according to claim 1, further comprises a wireless communication unit and/or a wired communication unit, used to send the key signal to a device.

4. The virtual keyboard according to claim 1, wherein the storage unit further stores object character information provided for recording how the vibration wave transmitted on the surface is affected by any one of the plurality of virtual keys pressed.

5. The virtual keyboard according to claim 1, wherein the surface is a plane on a platform, chosen from the group consisting of a rigid plate, a flexible plate and a piece of paper; wherein the plurality of virtual keys are a plurality of key patterns printed on the platform.

6. The virtual keyboard according to claim 5, wherein the platform further comprises a plurality of foot stands.

7. The virtual keyboard according to claim 6, wherein each of the plurality of foot stands further comprises a vibration-absorbing pad.

8. The virtual keyboard according to claim 5, wherein the platform further comprises a plurality of positioning protrusions, each of the plurality of positioning protrusions formed within one of the key patterns.

9. The virtual keyboard according to claim 1, further comprises a software interface executed on a device, enabling a user to input the data into the device.

10. The virtual keyboard according to claim 1, wherein the virtual region further comprises a virtual handwriting board and/or a virtual touch pad.

11. A virtual keyboard, used in a computing device having a storage unit used to store a plurality of data, each of the plurality of data recording an actual location and signification of each of the plurality of virtual keys, the virtual keyboard comprising:
a virtual region, formed on a surface, having a plurality of virtual keys;
at least two vibration sensors, provided on the surface; and
a processing unit, electronically connected to the vibration sensors and the storage unit;
wherein when a vibration signal is caused by touching the virtual region, each of the vibration sensors receives the vibration signal, whereby the processing unit generates a processing signal corresponding to the vibration signals to the computing device.

12. The virtual keyboard according to claim 11, further comprises a wireless communication unit and/or a wired communication unit, used to send the processing signal to the computing device.

13. The virtual keyboard according to claim 11, wherein the processing signal is time information and amplitude information of the vibration signal.

14. The virtual keyboard according to claim 11, wherein the processing signal is information of a vibration source location of the vibration signal.

15. The virtual keyboard according to claim 11, wherein the surface is a plane on a platform, chosen from the group consisting of a rigid plate, a flexible plate and a piece of paper; wherein the plurality of virtual keys are a plurality of key patterns printed on the platform.

16. The virtual keyboard according to claim 15, wherein the platform further comprises a plurality of foot stands.

17. The virtual keyboard according to claim 16, wherein each of the plurality of foot stands further comprises a vibration-absorbing pad.

18. The virtual keyboard according to claim 15, wherein the platform further comprises a plurality of positioning protrusions, each of the plurality of positioning protrusions formed within one of the key patterns.

19. The virtual keyboard according to claim 11, further comprises a software interface executed on the device, enabling a user to input the data into the device.

20. The virtual keyboard according to claim 11, wherein the virtual region further comprises a virtual handwriting board and/or a virtual touch pad.
